(19) United States
(12) Patent Application Publication
(10) Pub. No.: US 2013/0038530 A1
(43) Pub. Date: Feb. 14, 2013

(54) OPTICAL POINTING APPARATUS AND PORTABLE ELECTRONIC DEVICE COMPRISING SAME

(71) Applicant: Keon Joon An, Seongnam-si (KR)

(72) Inventor: Keon Joon An, Seongnam-si (KR)

(73) Assignee: CRUCIAL TEC CO., LTD., Asan-si, Chungcheongnam-do (KR)

(21) Appl. No.: 13/636,837

(22) PCT Filed: Mar. 24, 2011
(86) PCT No.: PCT/KR2011/002044

§ 371 Date: Nov. 5, 2012

(30) Foreign Application Priority Data
Mar. 24, 2010 (KR) 10-2010-0026022

(51) Int. Cl. G06F 3/033; B23P 17/04

(52) U.S. Cl. 345/157; 29/527.1

(57) ABSTRACT

Disclosed is s pointing device having enhanced visibility and aesthetics by providing a surface thereof with a light emitting zone for implementing decorative illumination, and a portable electronic apparatus including the pointing device. The pointing device includes a detector for detecting movement of an object; a housing including a housing body covering the detector and a light emitting zone provided in the housing body to allow visible light to be transmitted therethrough; a light source emitting illumination light containing visible light to illuminate the light emitting zone; and a light guide for changing a light path of the illumination light emitted from the light source so that the illumination light exits from the light emitting zone to an outside of the housing.

### TECHNICAL FIELD

The present invention relates to a pointing device and a portable electronic apparatus including the same, and more particularly, to a pointing device which may be applied as a user interface of an electronic apparatus such as portable terminals, and a portable electronic apparatus including the pointing device.

### BACKGROUND ART

In general, an electronic apparatus such as a mobile terminal or a PDA (Personal Digital Assistant) employs a user interface such as a key pad.

Specifically, a general portable electronic apparatus includes a key pad comprising a plurality of buttons for inputting numbers, letters, or symbols, and a user may push buttons of the key pad to input desired data such as numbers or words into the portable electronic apparatus or select a menu.

In addition, such a portable electronic apparatus is provided with a display unit, so that the display unit displays data input through the key pad and/or information related thereto.

Nowadays, in order to support a communication service or Internet service using an electronic apparatus, wireless mobile telecommunication and wireless internet services such as WiBro (Wireless Broadband) have been commercialized. A Windows operating system such as Windows CE is employed in a portable electronic apparatus such as a mobile terminal or a PDA in order to support a GUI (Graphical User Interface).

In addition, with the development of communications technology, the portable electronic apparatus provides a user with a variety of supplementary services, and a GUI-based Windows operating system facilitates the provision of the supplementary services by the portable electronic apparatus.

In order to conveniently use a general electronic apparatus, a pointing device such as a mouse has been applied as a user interface. Recently, a pointing device, which moves a pointer on a screen or receives information and/or commands desired by a user by emitting light and detecting an optical signal changed according to the movement of an object, i.e., a finger, is developed and applied to an electronic apparatus.

An optical pointing device, as an example of a conventional pointing device, includes a detection light source for emitting detection light, a housing, an image sensor for detecting an optical signal, and a light guide for guiding light to the image sensor.

The optical pointing device is provided separately from an electronic apparatus such as a notebook, so that the optical pointing device may be connected thereto by wire or wirelessly or alternatively mounted directly to a main body of the electronic apparatus. When the electronic apparatus is provided with the optical pointing device integrally, the electronic apparatus preferably has a structure having thickness minimized to slim the electronic apparatus.

In addition, an operation surface, i.e. an object detection zone, with which an object such as a finger comes into contact for operating the electronic apparatus, is formed on a surface of the housing, and the image sensor is disposed on a PCB for processing an input signal.

Accordingly, if the object, i.e., the finger, comes into contact with the operation surface and moves, the optical signal inputted into the image sensor is changed according to movement of the finger, and thus, the electronic apparatus may be operated according to movement of the finger.

In more detail, in a state in which the object is not in contact with the operation surface, the light emitted from the light source is transmitted through the housing and exits to the outside of the housing. However, if the object such as the finger comes into contact with the operation surface, i.e., the object detection zone, the light emitted from the light source strikes and is reflected from the object, passes through the light guide, and then, is incident on the image sensor. Since the operating principles of the optical pointing device are similar to those of a general optical mouse, repeated descriptions thereof will be omitted.

A conventional pointing device enhances convenience of an interface. However, since it is difficult to implement an aesthetic design of the pointing device or the overall design thereof is monotonous, the overall design of the electronic apparatus can be degraded. Thus, the present inventors developed an optical pointing device, which is visible even in a dark place and have enhanced aesthetics by implementing decorative illumination on the optical pointing device.

### DISCLOSURE

### Technical Problem

One aspect of the present invention is to provide a pointing device having enhanced visibility and aesthetics by providing a surface thereof with a light emitting zone for implementing decorative illumination, and a portable electronic apparatus including the pointing device.

### Technical Solution

In accordance with one aspect, the present invention provides a pointing device, which includes a detector for detecting movement of an object, a housing including a housing body covering the detector and a light emitting zone provided in the housing body to allow visible light to be transmitted therethrough, a light source emitting illumination light containing visible light to illuminate the light emitting zone, and a light guide for changing a light path of the illumination light emitted from the light source so that the illumination light exits from the light emitting zone to the outside of the housing; and a portable electronic apparatus including the pointing device.

The light guide may comprise a guide body accommodated within the housing and an illumination guide provided at the guide body to change the light path of the illumination light.

The illumination guide is provided on an outer wall of the guide body to disperse the illumination light such that the illumination light is widely spread in the light emitting zone to exit to the outside of the housing.

And the illumination guide comprises a plurality of reflective portions provided along a circumference of the guide body to reflect the illumination light, each of the reflective portions dispersing the illumination light emitted from the light source to both sides thereof.

Each of the reflective portions may comprise a reflective protrusion formed on an outer surface of the guide body, and a pair of inclined reflective surfaces defining both side surfaces of the reflective protrusion and having a gap therebetween gradually narrowed towards the light source.

The illumination guide may comprise a plurality of refractive portions provided along a circumference of the guide body to refract the illumination light, each of the refractive portions dispersing the illumination light emitted from the light source to both sides thereof.

The guide body may comprise a plurality of outer surfaces in a circumferential direction thereof; and the illumination guide comprises any one of a reflective portion and a refractive portion provided to each of the outer surfaces of the guide body along the circumference of the guide body, each reflective portion dispersing the illumination light toward both sides thereof by reflection, the refractive portion dispersing the illumination light toward both sides thereof by refraction.

And the illumination guide may comprise an eave disposed on an outer wall of the guide body to cover a front side of the light source. The eave has an inclined surface reflecting the illumination light to be spread along the illumination guide.

The guide body is integrally formed with the illumination guide or is inserted into the illumination guide to be surrounded by the illumination guide.

The guide body defines a path of detection light incident on the detector for detecting movement of the object.

The housing body comprises a cover having an object detection zone and a visible light transmitting portion allowing the illumination light to be transmitted therethrough and having the light emitting zone on a surface thereof, the light emitting zone is formed on the cover, and the object detection zone defines a contact surface of the object for detecting the object.

The light emitting zone can be provided along a circumference of the cover for surrounding the circumference of the cover. And the visible light transmitting portion and the cover are integrally formed with each other by double injection molding.

The visible light transmitting portion comprises a surface coating layer on an outer surface thereof to prevent leakage of the illumination light.

The surface coating layer may comprise a white coating layer for reflecting the illumination light such that the illumination light does not exit to the outside of the visible light transmitting portion. And the surface coating layer may further comprises a black coating layer formed on the white coating layer.

The object detection zone is illuminated by a detection light source provided within the housing. And the detection light source comprises an infrared source for emitting detection light containing an infrared band; and the object detection zone is an infrared band pass filter allowing substantially only an infrared band to pass therethrough and is illuminated by the infrared source.

The detection light source may comprise a laser light source. And the detector is capable of recognizing fingerprints. The light emitting zone forms decorative illumination of the housing.

The light emitting zone has a metal coating layer on a surface thereof. The metal coating layer is formed by NCVM (Non-Conductive Vacuum Metalizing).

In accordance with another aspect of the present invention, the present invention provides a light guide of a pointing device including a housing having a light emitting zone to implement decorative illumination on a circumference of a cover, a detector for detecting movement of an object, and a light source for illuminating the light emitting zone. Here, the light guide includes a guide body accommodated within the housing; and an illumination guide formed on the guide body to disperse illumination light emitted from the light source such that the illumination light is widely spread in the light emitting zone and exits to the outside of the housing.

In accordance with a further aspect, the present invention provides a method of manufacturing a housing of a pointing device, which includes: (a) manufacturing a housing body including a cover having an infrared band pass filter type object detection zone and a visible light transmitting portion allowing visible light to be transmitted therethrough to form a light emitting zone; (b) forming a surface coating layer on a circumference of the housing body to prevent leakage of illumination light, with a mask formed on a surface of the housing body to cover the light emitting zone and the object detection zone; and (c) forming a UV resin coating layer by coating the light emitting zone and the object detection zone with a UV resin after removing the mask.

The method may further comprise (d) performing NCVM treatment on an upper surface of the UV resin coating layer to form a metal coating layer, (e) forming an outer UV resin coating layer on the metal coating layer, and (f) removing portions of the UV resin coating layer, the metal coating layer and the outer UV resin coating layer formed on the surface of the object detection zone.

The step (b) may comprise (b1) forming a white coating layer on the circumference of the housing and (b2) forming a black coating layer on the white coating layer.

### Advantageous Effects

According to a pointing device and a portable electronic apparatus including the same of the present invention, there are the following advantages.

First, according to the present invention, a light emitting zone for decorative illumination is provided in a housing of a pointing device, so that light sources cause the light emitting zone to emit light. Thus, the pointing device is visible even in a dark place, and aesthetics of a variety of electronic apparatuses having the pointing devices mounted thereto can also be improved.

Second, according to the present invention, it is possible to implement decorative illumination of various colors according to colors of the light sources illuminating the light emitting zone. Since a light guide accommodated in the housing for the decorative illumination defines a path of detection light for detecting an object, the internal structure of the pointing device can be simplified.

Third, according to the present invention, the light sources for illuminating the light emitting zone prevent a point light source from being formed on a surface of the housing. The illumination light of the light sources is dispersed to be widely spread and output on the light emitting zone. Accordingly, it is possible to improve aesthetics of the decorative illumination and to prevent a dark (shadow) portion from being formed in an edge or tip of the light emitting zone. Also, the number of the light sources for implementing the decorative illumination can be reduced.

Fourthly, according to the present invention, since in a state in which the light emitting zone is not illuminated by the light sources, a metallic colored pattern can be realized in the housing, designs of the pointing device and the electronic apparatus can be improved.

Fifthly, according to the present invention, since the light emitting zone allows visible light to be transmitted therethrough and the object detection zone substantially allows only an ultraviolet band to be transmitted therethrough, the light sources for illuminating the light emitting zone can minimize or prevent malfunction of the pointing device.

### DESCRIPTION OF DRAWINGS

The above and other aspect, features and advantages of the present invention will become apparent from the following description of exemplary embodiments given in conjunction with the accompanying drawings, in which:

FIG. 1 is an exploded perspective view of a pointing device according to a first embodiment of the present invention;

FIG. 2 is a cross-sectional view of a housing of the pointing device of FIG. 1;

FIG. 3 is a perspective view of a light guide of the pointing device of FIG. 1;

FIG. 4 is a cross-sectional view of an illumination light path of the pointing device of FIG. 1;

FIG. 5 is a cross-sectional view of a detection light path of the pointing device of FIG. 1;

FIG. 6 is a perspective view of a portable electronic apparatus including a pointing device according to the present invention;

FIG. 7 is an exploded perspective view of a pointing device according to a second embodiment of the present invention;

FIG. 8 is an exploded perspective view of a light guide of the pointing device of FIG. 7;

FIG. 9 is a front view of the light guide of FIG. 8;

FIG. 10 is a cross-sectional view of an illumination light path of the pointing device of FIG. 7;

FIG. 11 is an exploded perspective view of a pointing device according to a third embodiment of the present invention;

FIG. 12 is a perspective view of a light guide of the pointing device of FIG. 11;

FIG. 13 is a plan view of a housing of the pointing device of FIG. 11;

FIG. 14 is a cross-sectional view of the housing of the pointing device of FIG. 11;

FIG. 15 is a cross-sectional view of an illumination light path of the pointing device of FIG. 11;

FIG. 16 is a cross-sectional view of the pointing device according to a fourth embodiment of the present invention; and

FIG. 17 is a view of a process of manufacturing the housing of the pointing device according to the present invention.

### BEST MODE

Next, exemplary embodiments of the present invention will be described in detail with reference to the accompanying drawings. In description of the embodiments, like terms and reference numerals will be used to designate like elements, and repeated descriptions thereof will be omitted.

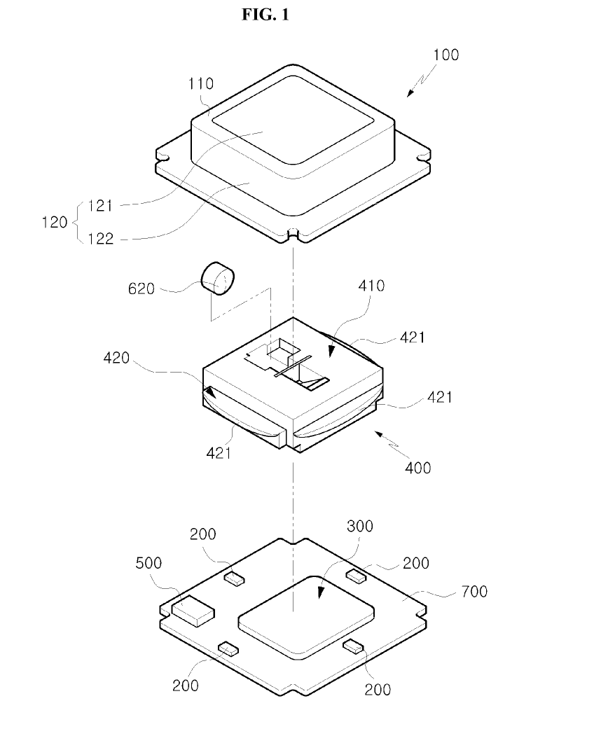

First, referring to FIGS. 1 to 5, a pointing device according to one exemplary embodiment of the present invention will be described.

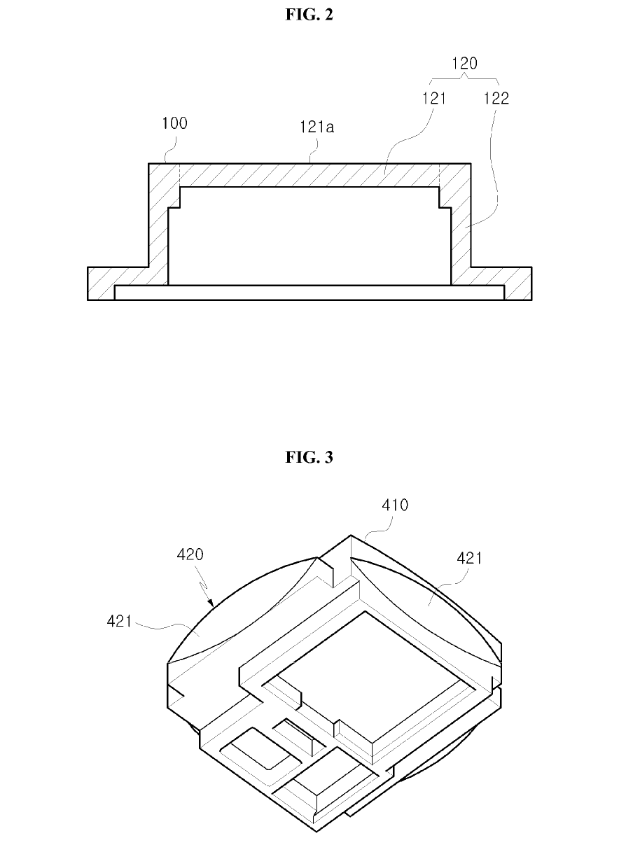

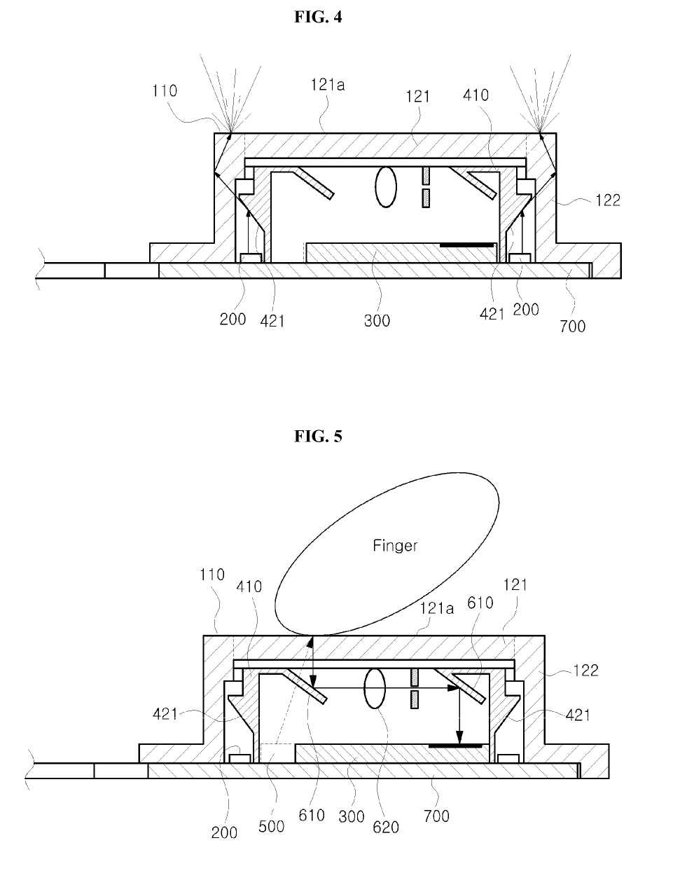

FIG. 1 is an exploded perspective view of a pointing device according to a first embodiment of the present invention, FIG. 2 is a cross-sectional view of a housing of the pointing device of FIG. 1, FIG. 3 is a perspective view of a light guide of the pointing device of FIG. 1, FIG. 4 is a cross-sectional view of an illumination light path of the pointing device of FIG. 1, and FIG. 5 is a cross-sectional view of a detection light path of the pointing device of FIG. 1.

Referring to FIGS. 1 to 4, the pointing device according to the first embodiment of the present invention includes a housing 100, light sources 200, a detector 300, and a light guide 400. The detector 300 is covered with the housing 100, and the light sources 200 emit illumination light for providing the pointing device with decorative illumination.

In addition, the detector 300 is provided inside of the housing 100 to detect movement of an object and is further capable of recognizing fingerprints. Since a pointing device capable of recognizing fingerprints has been known, additional description thereof will be omitted. As one example of the detector 300, an image sensor may be employed to detect information on an object and to convert the information into an electrical image signal.

In this embodiment, the housing 100 has a cap shape, with one side thereof, for example a bottom, open. The housing 100 protects the internal components of the pointing device, e.g., the detector 300 and the light sources 200, and defines an external appearance of the pointing device. In the present invention, the housing 100 includes a light emitting zone 110 and a housing body 120.

The light emitting zone 110 is provided in the housing body 120 and illuminated by the light sources 200, so that decorative illumination is implemented on a surface of the housing 100. Each of the light sources 200 emits illumination light including visible light and may include, for example, at least any one of a white LED and colored LEDs (red, green, and blue LEDs).

In addition, the housing body 120 includes a cover 121 having an object detection zone 121a, and a visible light transmitting portion 122 which allows the illumination light to be transmitted therethrough to the light emitting zone 110, which is disposed on a surface of the visible light transmitting portion 122.

In this embodiment, the housing body 120 has a substantially quadrangular cap shape having one open side. When the cover 121 is an upper cover of the housing body, the housing body 120 has a shape with a bottom open. In addition, the visible light transmitting portion 122 defines a circumferential wall of the housing body 120, but the shape of the housing body 120 is not limited thereto.

Here, the object detection zone 121a is a surface with which the object comes into contact for detecting the object, and the light emitting zone 110 is provided in the cover 121, more specifically along a circumference of the cover 121.

In this embodiment, the light emitting zone 110 is provided along the circumference of the cover 121 to extend in a line shape having a predetermined width, more specifically in a closed loop shape, particularly a quadrangular loop, surrounding the circumference of the cover 121. Thus, the object detection zone 121a is positioned inside of the light emitting zone 110.

The cover 121 may be molded integrally with the visible light transmitting portion 122 defining a circumferential wall, i.e., a rim, of the housing body 120, or assembled to the circumference of the housing body 120 to define the upper cover of the housing 100.

The visible light transmitting portion 122 may be made, for example, of transparent or translucent plastic and further have a predetermined color. In addition, as in a fourth embodiment, which will be described below, the outer surface of the visible light transmitting portion 122, i.e., the circumferential wall of the housing body 120 may be formed with a surface coating layer for preventing the illumination light from leaking.

The surface coating layer reflects the illumination light exiting to the outside of the visible light transmitting portion 122 so that the illumination light passes through the inside of the visible light transmitting portion 122 and then proceeds to the light emitting zone 110. The surface coating layer includes a white coating layer for surface reflecting the illumination light, and a black coating layer may be further formed on the white coating layer.

In order to detect the object, a signal generating source 500 is provided inside of the housing 100 to generate a detection signal, and the detection signal is detected by the detector depending on movement of the object. The signal generating source 500 includes a detection light source for emitting light (detection light). Hereinafter, the reference numeral of the signal generating source is used as that of the detection light source.

The object detection zone 121a of the cover 121 is illuminated by the detection light source 500 provided inside of the housing 100 and transmits the detection light emitted from the detection light source 500.

For convenience of illustration, hereinafter, the light source 200 for emitting illumination light will be referred to as an illumination light source. In this embodiment, the detection light source 500 includes an infrared (IR) source for emitting detection light containing an infrared band, but the detection light source is not limited thereto and may be modified in various ways. For example, the detection light source 500 may also include a laser light source for emitting laser light.

When the detection light source 500 emits infrared light as in this embodiment, the object detection zone 121a functions as an infrared band pass filter which allows substantially only the infrared band to pass.

For example, the infrared band pass filter is disposed on a surface of the cover 121, so that light in a band other than the infrared band, e.g., a visible light can be prevented from being introduced into the housing 100. The infrared band pass filter may be a filter layer in the form of a film attached to the surface of the cover 121, or a coating filter layer formed by application of a material allowing only the infrared band to be transmitted therethrough.

For example, the infrared band pass filter may also include a coating layer formed by stacking high and low refractive materials, such as TiO₂ and SiO₂ or TiO₅ and SiO₂, on the surface of the cover 121. Here, TiO₂ and TiO₅ have high indices of refraction and SiO₂ has a low index of refraction. In addition, the infrared pass material may be applied as a multi-layered film by a vacuum vapor deposition method using a vacuum vapor deposition apparatus or the like.

The infrared band pass filter allows substantially only the infrared band to be transmitted therethrough and blocks or weakens the transmission of beams in bands other than the infrared band. Here, transmitting substantially only the infrared band means that most of broadband transmitted by the infrared band pass filter is an infrared wavelength band.

Of course, the cover 121 may also be made of optical plastics of an infrared band pass filter. That is, optical plastics for allowing a specific wavelength band to be transmitted therethrough may be formed by injection molding a resin having dye or pigment particles added thereto. A transmitted wavelength band may vary depending on the kind/amount of the dye or pigment. Since the band pass technique, such as the aforementioned infrared band pass filter, is a general technique in the field of optical filters, details thereof will be omitted.

Accordingly, introduction of visible light through the object detection zone 121a is prevented, so that malfunction of the pointing device due to an external light source or the illumination light source 200 can be minimized or prevented.

In addition, as in the fourth embodiment, which will be described below, the light emitting zone 110 is covered with a metal coating layer, so that a silver metallic color may be realized on a surface of the light emitting zone 110. In this embodiment, the metal coating layer is formed by NCVM (Non-Conductive Vacuum Metalizing) treatment, but the present invention is not limited thereto.

In this embodiment, the cover 121 is a structure molded integrally with the circumferential wall of the housing body 120, i.e., the visible light transmitting portion 122. In more detail, the housing body 120 may be formed by injection molding a synthetic resin, wherein the cover 121 of an optical plastic material allowing only an infrared band to pass therethrough may be integrally formed with the transparent or translucent visible light transmitting portion 122 by injection molding. PMMA (polybutylmethacrylate), PC (polycarbonate), or the like may be used as a material for the visible light transmitting portion 122.

On the contrary, after the housing body 120 having a cap shape and allowing visible light to be transmitted therethrough is molded using an injection molding machine, the surfaces of the cover 121, particularly outer and inner surfaces thereof are coated with an infrared band pass filter, whereby the cover 121 may be formed with the object detection zone 121a detected using infrared light.

The visible light transmitting portion 122 does not directly define the circumferential wall of the housing body 120, but the housing body 120 includes an additional circumferential wall separate from the visible light transmitting portion 122, which may be formed on an inner peripheral surface of the wall to define a portion of the housing 100.

Referring to FIGS. 3 and 4, the light guide 400 includes a guide body 410 accommodated within the housing 100, and an illumination guide 420 for changing an illumination light path. In more detail, the illumination guide 420 is formed on the guide body 410 to change the direction of the illumination light towards the visible light transmitting portion 122, and the illumination guide 420 changes the direction of the illumination light by refraction and/or reflection of the light.

In addition, in order for the light emitting zone 110 to implement the decorative illumination in the form of a surface light source, the illumination guide 420 disperses the illumination light to be wide, and thus illumination light is widely spread in the light emitting zone 110 to thereby exit to the outside of the housing.

Since, if the illumination guide 420 does not disperse the illumination light, the illumination light is present in the form of point light in the front of the illumination light source 200, i.e., a directly upper part thereof, the illumination guide 420 redirects the illumination light emitted from the illumination light source 200 to be widely dispersed so that the light emitting zone 110 emits illumination light to be generally soft.

The illumination guide 420 is disposed on an outer wall of the guide body 410 in this embodiment, although the illumination guide 420 may be provided in an inner wall of the housing 100. In more detail, the illumination guide 420 includes a plurality of reflective portions 421 disposed along a circumference of the guide body 410.

Each of the reflective portions 421 reflects the illumination light and simultaneously widely disperses the illumination light toward both sides of the reflective portion 421. The reflective portion 421 protrudes from an outer surface of the guide body 410, i.e., an outer wall thereof, and widely diffuses/disperses the illumination light in a lengthwise direction of the light emitting zone.

In this embodiment, the reflective portion 421 has a reflective surface, which is inclined upwards to have a gradually increasing thickness towards the center thereof with a spherical or planar surface at either side thereof. When the cover 121 is considered as the upper cover, the illumination light source 200 emits illumination light from under the reflective portion 421, but if the position of the illumination light source 200 is modified, the position and size of the reflective portion 421 may be changed.

In addition, the illumination guide 420 defines an eave for covering the front of the illumination light source 200, thereby preventing the illumination light source 200 from making point light in the housing 100. The eave has an upwardly inclined surface, which protrudes from the guide body 410 to have a gradually increasing thickness towards an upper portion thereof and is gradually inclined upwards from a middle portion of the eave towards the opposite sides and the front side thereof. Accordingly, the surface of the eave is gradually inclined from a tip (a leading end) of the eave to a lower side thereof to approach the guide body 410.

In this embodiment, each of the reflective portions 421 defines the eave, which has a upwardly inclined shape so that the surface of the reflective portion 421 protrude from the guide body 410 to have a gradually increasing thickness towards the upper portion thereof. The surface of the reflective portion 421 is coated with a reflective material to form a reflective surface.

Although the illumination guide 420 has been described as integrally formed with the guide body 410, the present invention is not limited thereto and they may be separately manufactured and then assembled.

In this embodiment, the guide body 410 has a plurality of outer surfaces in a circumferential direction thereof, and the illumination guide 420, particularly the reflective portions 421, are disposed on each of the outer surfaces of the guide body 410. Further, the guide body 410 has a substantially quadrangular shape, and the four outer surfaces thereof are respectively provided with the reflective portions 421.

A predetermined interval is defined between the circumference of the guide body 410 and the inner surface of the housing 100, particularly the inner wall of the housing body 120 defining the visible light transmitting portion 122. The plurality of illumination light sources 200 are provided between the inner wall of the housing body 120 and the circumference of the guide body 410. In addition, the illumination guide 420, particularly the reflective portions 421 protrude from the outer wall of the guide body 410 toward the inner wall of the housing body 120 to define the eave, which in turn covers the upper portion of the illumination light sources 200.

Further, the illumination light incident on the visible light transmitting portion 122 in a dispersed state by the illumination guide 420 is diffused while being transmitted through the visible light transmitting portion 122 and exits to the outside of the housing 100 via the light emitting zone 110 to thereby implement decorative illumination.

The guide body 410 defines a path of detection light incident on the detector 300 in the object detection zone 121a so that movement of the object is detected by the detector 300.

For example, the guide body 410 is provided with an optical unit for changing the detection light path, thereby guiding the detection light to the detector 300. In this embodiment, the optical unit includes a pair of reflective members 610, an imaging lens 620 and the like. Here, the imaging lens 620 is installed between the reflective members 610.

In addition, the detector 300 is mounted on a circuit board 700 defining a bottom of the housing, the guide body 410 is provided above the detector 300, and the cover 121 is provided over the guide body 410.

A partition protrusion is formed to protrude from at least one surface (an upper surface) of the guide body 410 facing the cover 121 and an inner surface (a bottom surface) of the cover. The partition protrusion blocks spill light (for example, the illumination light) out of the guide body 410, particularly the partition protrusion, thereby preventing the spill light from being introduced to the detector 300.

In addition, as in this embodiment, when the light emitting zone 110 has a shape surrounding the circumference of the cover 121, a plurality of the illumination light sources 200 are provided around the guide body 410. In this embodiment, four illumination light sources 200 are provided around the guide body 410.

The illumination light sources 200 and the detection light source 500 may be mounted on the circuit board 700 or, alternatively, placed at other regions inside of the housing 100.

Referring to FIG. 4, the illumination light emitted from the illumination light source 200 is widely dispersed by the illumination guide 420, i.e., the reflective portion 421, and enters the visible light transmitting portion 122. Then, the dispersed illumination light incident on the visible light transmitting portion 122 is diffused and exits to the outside of the housing 100 via the light emitting zone 110, so that the decorative illumination is implemented on the surface of the housing 100.

In the present invention, the light emitting zone 110 is configured to have four sides. Since the illumination guide 420 widely disperses light in a lengthwise direction with respect to each side of the light emitting zone, it is possible to implement uniform brightness even at corners where the respective sides join.

Referring to FIG. 5, the detection light emitted from the detection light source 500 is reflected by an object brought into contact with the object detection zone 121a and then enters the detector 300 via the pair of reflective members 610 and the imaging lens 620. Accordingly, movement of the object is detected by the detector, and movement of a pointer on a screen of an electronic apparatus can be implemented according to a change of an electrical signal.

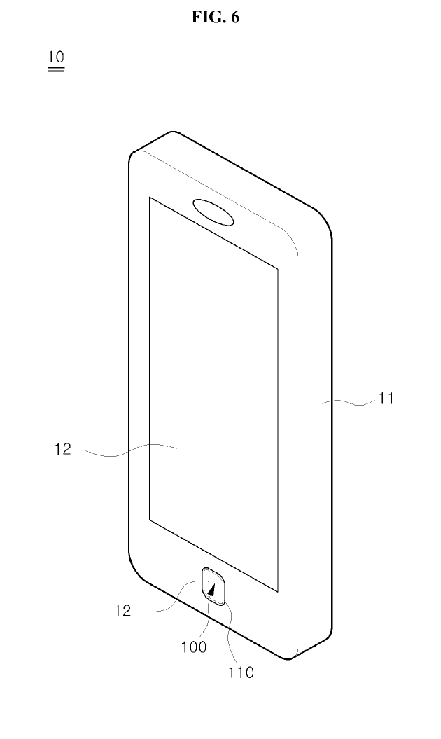

FIG. 6 shows one embodiment of a portable electronic apparatus, to which a pointing device according to the present invention is applied, illustrating an example of a smartphone actively used lately.

A portable electronic apparatus 10 includes a pointing device according to the present invention as described above, and a main body 11 disposed with the pointing device. The main body 11 is provided with a screen 12 for display. The light emitting zone 110 and the cover 121 of the housing are exposed to the outside of the main body 11 to define part of design of the portable electronic apparatus.

The aforementioned illumination light source 200 may serve both to emit the illumination light and to emit the detection light. For example, the object detection zone 121a is illuminated when the object is brought into contact with the object detection zone, while the light emitting zone 110 is illuminated when the object is not brought into contact with the object detection zone. In such a case, the detection light source 500 need not be applied to the inside of the housing 100.

### MODE FOR INVENTION

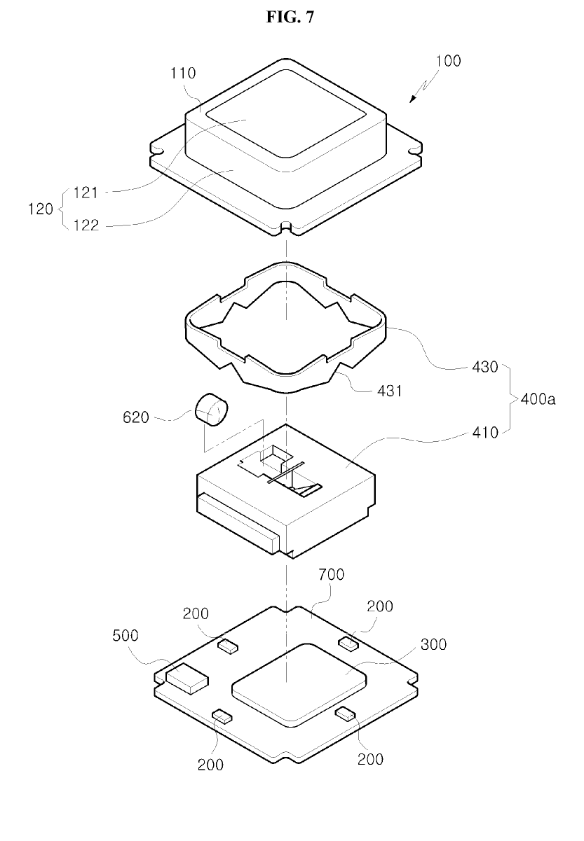

Next, a pointing device according to a second embodiment of the present invention will be described with reference to FIGS. 7 to 10.

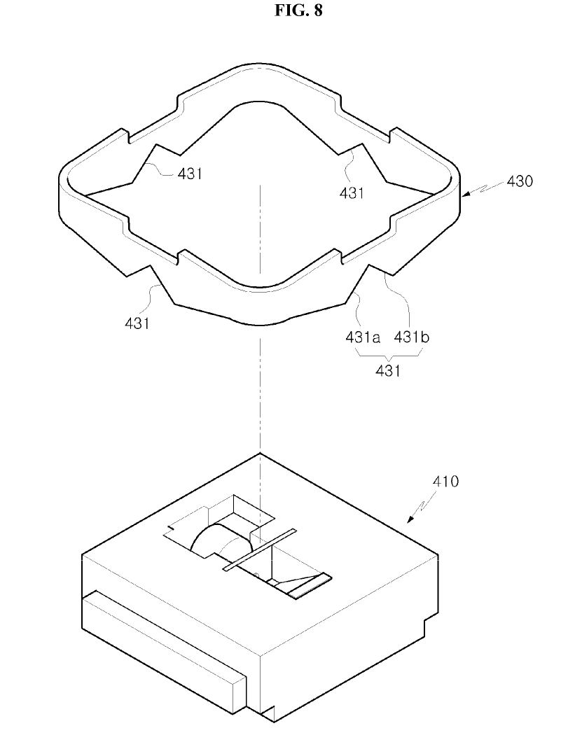

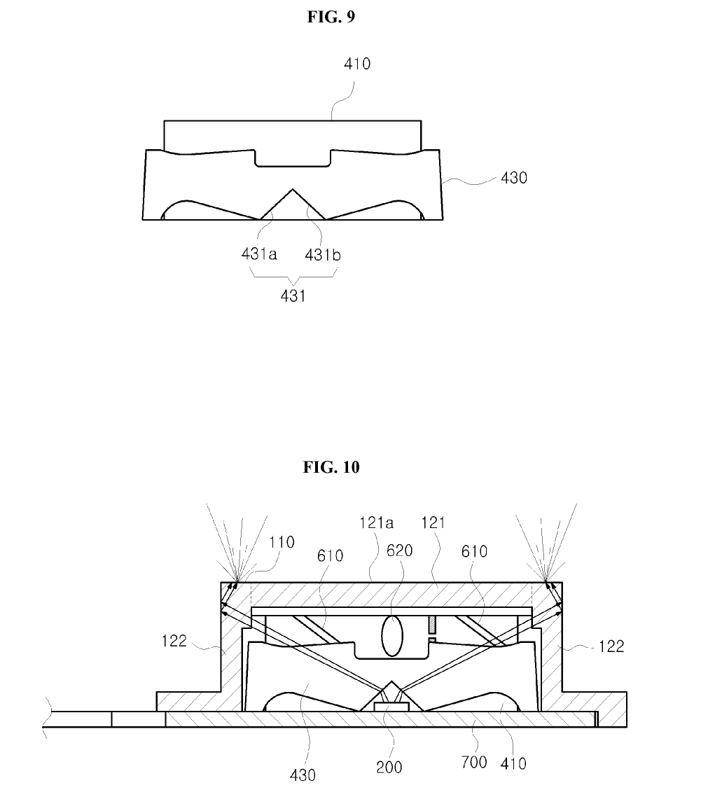

Here, FIG. 7 is an exploded perspective view of a pointing device according to a second embodiment of the present invention; FIG. 8 is an exploded perspective view of a light guide of the pointing device of FIG. 7; FIG. 9 is a front view of the light guide of FIG. 8; and FIG. 10 is a cross-sectional view of an illumination light path of the pointing device of FIG. 7.

Referring to FIGS. 7 to FIG. 10, the pointing device of this embodiment includes a housing 100, light sources 200, a detector 300 and a light guide 400a. Since the technical spirit regarding the housing 100, the light sources 200 and the detector 300 described in the above embodiment can be applied to this embodiment in the same manner, repeated description thereof will be omitted and like reference numerals are used to designate like elements.

The light guide 400a includes a guide body 410 and an illumination guide 430, which includes a plurality of refractive portions 431 formed along the circumference of the guide body 410. Each of the refractive portions 431 refracts illumination light emitted from the light source 200, i.e. the illumination light source, to be spread to both ends thereof.

In this embodiment, each of the refractive portions 431 has a triangular notch shape open toward the corresponding illumination light source 200. The illumination light is refracted in both directions while entering both side surfaces of the refractive portion 431 and dispersed in both left and right sides of the refractive portion 431 while being transmitted through the refractive portion 431. Then, the illumination light enters a visible light transmitting portion 122 of the housing.

Then, the illumination light entering the visible light transmitting portion 122 is transmitted through the visible light transmitting portion 122 to be widely diffused, and then the light exits to the outside of a light emitting zone 110.

The illumination guide 430 is coupled to the circumference of the guide body 410, and in more detail, the guide body 410 is inserted into the illumination guide 430 to be mutually fixed.

The illumination guide 430 has a closed loop shape, which is vertically penetrated, and the plurality of the refractive portions 431 are formed along the circumference of the illumination guide 430. The illumination guide 430 is made of a transparent or translucent synthetic resin material. The plural illumination light sources 200 emit illumination light toward respective refractive portions within the housing.

In this embodiment, the illumination light sources 200 and the refractive portions 431 are arranged to correspond to each other on a one-to-one basis, but the present invention is not limited thereto. For example, the illumination light sources 200 and the refractive portions 431 may be arranged on a one-to-many basis.

When the guide body 410 has a polygonal shape, e.g., a quadrangular shape, as described in the above embodiment, at least one of the refractive portions 431 is provided in the circumference of the guide body 410, i.e., four outer surfaces thereof, and in more detail, the refractive portion is provided in a center of each outer surface. Also, the refractive portion 431 is spaced apart from the illumination light source 200 by a predetermined interval.

The other components except the light guide 400a are the same as described in the above embodiment, and the detection light source 500 in the above embodiment may also be applied to this embodiment in the same manner. Accordingly, a repeated description will be omitted.

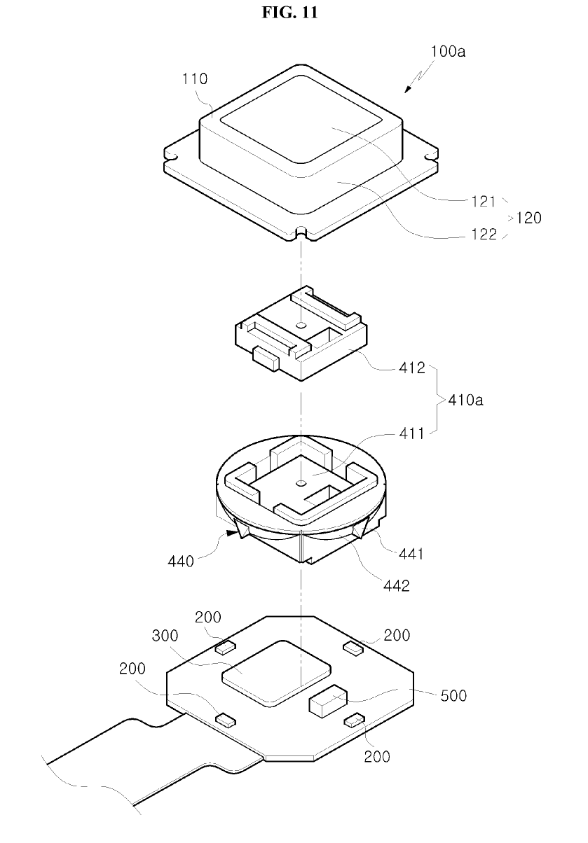

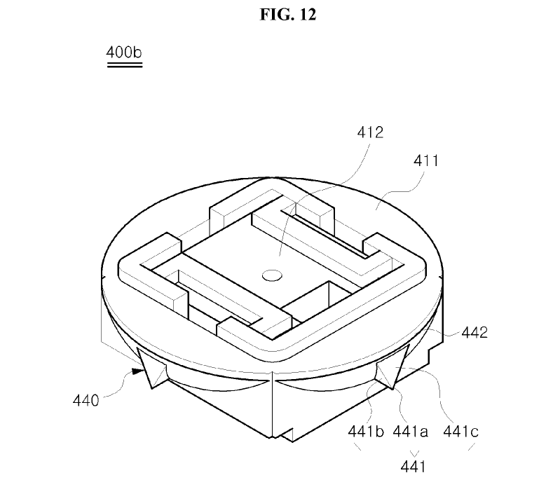

Next, a pointing device according to a third embodiment of the present invention will be described with reference to FIGS. 11 to 15.

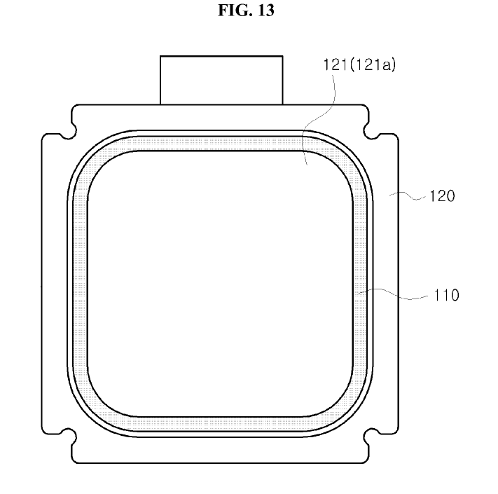

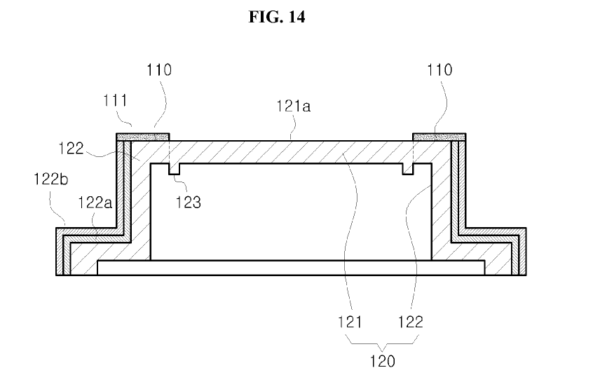

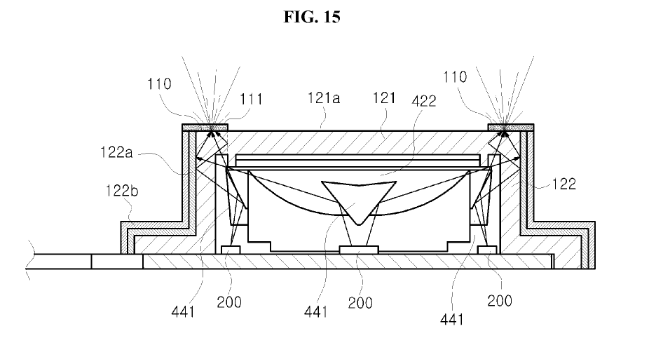

FIG. 11 is an exploded perspective view of a pointing device according to a third embodiment of the present invention; FIG. 12 is a perspective view of a light guide of the pointing device of FIG. 11; FIG. 13 is a plan view of a housing of the pointing device of FIG. 11; FIG. 14 is a cross-sectional view of the housing of the pointing device of FIG. 11; and FIG. 15 is a cross-sectional view of an illumination light path of the pointing device of FIG. 11.

Referring to FIGS. 11 to 15, the pointing device according to the third embodiment includes a housing 100a, light sources 200, a detector 300, and a light guide 400b.

The light guide 400b includes a guide body 410a and an illumination guide 440. In this embodiment, the guide body 410a includes a base body 411 and an upper body 412 mounted on the base body 411, and the illumination guide 440 includes a plurality of reflective portions 441 provided along the circumference of the guide body 410a.

Each of the reflective portions 441 reflects light emitted from the light sources 200, i.e. the illumination light sources, toward both sides thereof and then widely spreads the illumination light toward both sides of the reflective portion 441. In this embodiment, each of the reflective portions 441 has a reflective protrusion 441a protruding towards the outside of the guide body 410 and a pair of reflective surfaces 441b disposed on the reflective protrusion 441a.

In this embodiment, the reflective protrusion 441a has a substantially triangular pyramid shape such that an apex thereof faces the illumination light source 200. The illumination light source 200 emits illumination light toward the apex of the reflective protrusion 441a. However, if the position of the illumination light source 200 is changed, the position or shape of the reflective protrusion 441a may also be changed.

The pair of reflective surfaces 441b is formed on two sides of the reflective protrusion 441a, respectively. Accordingly, the reflective protrusion has an inclined shape with a gap between the reflective surfaces 441b gradually narrowed towards the illumination light source 200. That is, the reflective protrusion has an upwardly inclined shape on the two sides thereof. Also, a front surface 441c of the reflective protrusion 441a is inclined upwards to protrude in the front side to have a gradually increasing thickness in an upward direction (in an exit direction of illumination light), whereby light emitted from the illumination light source 200 may be reflected in the upward direction in the front side.

In addition, the illumination guide 440 may further include an eave 442 for covering the front of the illumination light source 200. The eave 442 prevents the illumination light of the illumination light source 200 from providing point light in the housing 100a. A surface of the eave 442 is inclined upwards so that the eave 442 gradually thickens towards an upper portion of the guide body 410, and is inclined upwards from a middle portion of the eave toward both sides thereof. Also, the reflective protrusion 441a is positioned in the middle of the eave 442, and surfaces of the eave 442 and the reflective protrusion 441a are coated with reflective layers.

In this embodiment, the illumination guide 440, particularly the reflective portions 441 are integrally formed with the circumference of the guide body 410a, and the illumination light emitted from the illumination light source 200 is widely dispersed by the reflective portions 441 and then enters the housing 100a.

In this embodiment, the housing 100a includes a light emitting zone 110 and a housing body 120. The light emitting zone 110 is provided in the housing body 120 and illuminated by the illumination light source 200, so that decorative illumination is implemented on a surface of the housing 100.

Referring to FIGS. 13 and 14, the housing body 120 includes a cover 121 having an object detection zone 121a, and a visible light transmitting portion 122 which allows the illumination light to be transmitted to the light emitting zone 110, which is disposed on the surface of the visible light transmitting portion 122.

In this embodiment, the housing body 120 has a substantially quadrangular cap shape having one side open. When the cover 121 is an upper cover of the housing body, the housing body 120 has a shape with an open bottom. In addition, the visible light transmitting portion 122 defines a circumferential wall of the housing body 120, but the shape of the housing body 120 is not limited thereto.

In this embodiment, the light emitting zone 110 is provided along the circumference of the cover 121 to extend in a line shape having a predetermined width, more specifically, in a closed loop shape, particularly a quadrangular loop, surrounding the circumference of the cover 121. Thus, the object detection zone 121a is positioned inside of the light emitting zone 110.

The cover 121 may be molded integrally with the visible light transmitting portion 122 defining a circumferential wall, i.e., a rim, of the housing body 120, or assembled to the circumference of the housing body 120 to define the upper cover of the housing 100a. In addition, the outer surface of the visible light transmitting portion 122, i.e., the circumferential wall of the housing body 120 is formed with surface coating layers 122a and 122b to prevent the illumination light from leaking.

The surface coating layers 122a and 122b reflect the illumination light exiting to the outside of the visible light transmitting portion 122 so that the illumination light passes through the inside of the visible light transmitting portion 122 and then proceeds to the light emitting zone 110. The surface coating layers 122a and 122b include a white coating layer 122a for surface reflecting the illumination light, and a black coating layer 122b may be further formed on the white coating layer.

In addition, the object detection zone 121a of the cover 121 is illuminated by the detection light source 500 provided inside of the housing 100a and transmits the detection light emitted from the detection light source 500.

The light emitting zone 110 is covered with a metal coating layer 111, so that a silver metallic color may be realized on a surface of the light emitting zone 110. In this embodiment, the metal coating layer 111 is formed by NCVM (Non Conductive Vacuum Metalizing), without being limited thereto.

At least any one of an inner surface (a bottom surface) of the cover 121 and a surface (an upper surface) of the guide body 410 facing the inner surface of the cover 121 is formed with a partition protrusion 123 that protrudes toward the other one thereof. The partition protrusion 123 prevents spill light out of the guide body 410, particularly the partition protrusion 123, from being introduced into the guide body 410. In this embodiment, the partition protrusion 123 has a closed loop shape protruding from a bottom of the cover 121 toward the guide body 410.

The light guide and the housing described in the above embodiments can be applied to this embodiment in the same manner, except the aforementioned structures of the light guide 400b and the housing 100a. Thus, additional description of the light guide 400b and the housing 100a will be omitted. Since the above embodiments may be applied to the other components except the light guide 400b and the housing 100a in the same manner, repeated description thereof will be omitted.

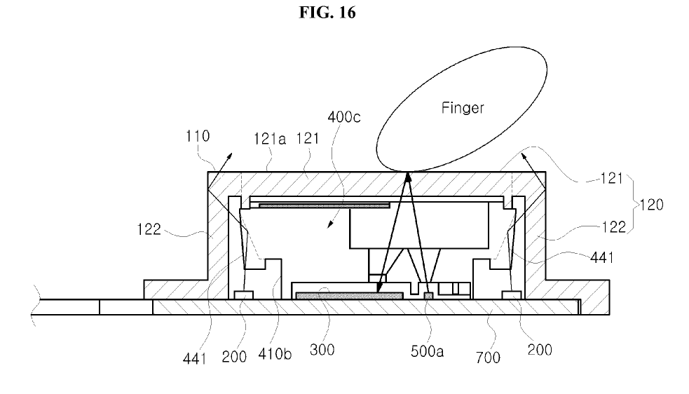

Next, referring to FIG. 16, a pointing device according to a fourth embodiment of the present invention will be described. In this embodiment, the pointing device, which is a laser pointing device using a laser light source as a detection light source, includes a housing 100, light sources 200, a detector 300, a light guide 400c, and a detection light source 500. The light guide 400c includes a guide body 410b and an illumination guide.

However, the guide body 410b defines a path for laser detection light, and the technical spirit described in the above embodiments may be applied to the other components except the path of the detection light in the same manner. Thus, additional descriptions for this embodiment will be omitted, and like reference numerals are used to designate like elements.

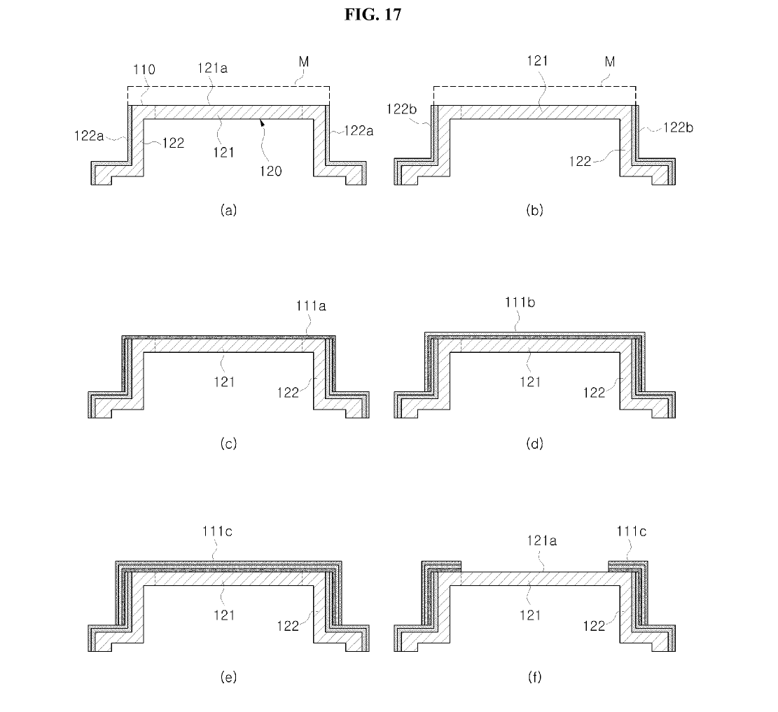

Next, referring to FIG. 17, a method of manufacturing a housing of the pointing device according to one embodiment of the invention will be described.

Referring to FIG. 17, a method of manufacturing a housing according to this embodiment, wherein the housing has a light emitting zone for decorative illumination, includes: (a) manufacturing a housing body 120, (b) forming surface coating layers 122a and 122b on a circumference of the housing body 120, and (c) forming a UV resin coating layer 111a on the housing body 120.

In step (a), the housing body 120, which includes a cover 121 having an object detection zone 121a of an infrared band pass filter type and a visible light transmitting portion 122 allowing visible light to be transmitted therethrough to form a light emitting zone, is manufactured.

In one example of the method of manufacturing the housing body 120, an infrared band pass filter layer (not shown) is formed on a surface of the cover 121 after manufacturing a perform of the housing body 120 by injection molding transparent or translucent synthetic resin. In another example of the method, the cover 121 and the visible light transmitting portion 122 are formed by double injection molding different materials. In the latter method, the cover 121 is made of a plastic material allowing only the infrared band to be transmitted therethrough, and the visible light transmitting portion 122 is made of a transparent or translucent plastic material. By controlling the kind and/or amount of dye or pigment used when injection molding the cover 121, the cover 121 may function as an infrared band pass filter. Since the techniques of manufacturing a plastic material substantially allowing only a specific frequency band to be transmitted therethrough are generally known in the field of plastics and filters, an additional description will be omitted.

Then, in step (b) of forming surface coating layers on the circumference of the housing body 120, after a mask M is formed on the surface of the housing body 120, i.e., the surface of the cover 121 so as to cover the light emitting zone and the object detection zone, the surface coating layers 122a, 122b are formed on the circumference of the housing body to prevent leakage of the illumination light.

In more detail, step (b) includes the steps of (b1) forming a white coating layer 122a on the circumference of the housing body 120 and (b2) forming a black coating layer 122b on the white coating layer.

The white coating layer 122a is a reflective layer which total-reflects the illumination light incident on the visible light transmitting portion via an inner face of the visible light transmitting portion 122. Also, the black coating layer 122b is formed on the white coating layer 122a to protect the white coating layer 122a and simultaneously prevent the illumination light from leaking.

The black coating layer 122b may be formed, for example, by application of a mixture of a hydrocarbon solvent, an acryl resin, a ketone solvent, a black pigment and a matting agent by a spraying method or the like. Since the white coating layer itself for total reflection of visible light is also generally known in the field of waveguides or optics, an additional description will be omitted.

Then, the UV resin coating layer 111a is formed in such a manner that the mask M is removed from the surface of the housing body 120 and the light emitting zone 110 and the object detection zone 121a are then coated with a UV resin. The UV resin coating layer 111a may be formed even on the circumference of the housing body 120, i.e., the outer surface of the visible light transmitting portion 122 to thereby be formed on the black coating layer 122b.

The method may further includes: (d) performing NCVM treatment on an upper surface of the UV resin coating layer 111a to form a metal coating layer 111b; (e) forming an outer UV resin coating layer 111c on the metal coating layer 111b; and (f) removing portions of the UV resin coating layer 111a, the metal coating layer 111b and the outer UV resin coating layer 111c that covers the surface of the object detection zone 121a while leaving a portion thereof covering the light emitting zone 110. The step (f) may be performed by burning treatment, such as laser etching or the like.

Thus, the metal coating layer 111b remains on the surface of the light emitting zone 110, so that a metallic color may be formed in the light emitting zone 110.

It will be apparent to those skilled in the art that the present invention may be realized by different ways in addition to the aforementioned embodiments without departing from the spirit and scope of the invention.

Thus, it should be understood that these embodiments are provided for illustration only and are not construed in any way as limiting the spirit of the present invention. Accordingly, the present invention is not limited to the detailed description of the invention, and various modifications, changes and alterations can be made without departing the scope of the invention, as defined only by the appended claims and the equivalents thereto.

### INDUSTRIAL APPLICABILITY

As an interface for electronic apparatuses, a pointing device according to the present invention may be applied to various portable electronic products, such as mobile terminals including smartphones, remote controllers, navigators, etc., to realize decorative illumination. Therefore, the pointing device according to the present invention advantageously enhances visibility and aesthetics of the portable electronic products while improving design thereof.

1. A pointing device, comprising:
a detector for detecting movement of an object;
a housing including a housing body covering the detector and a light emitting zone provided in the housing body to allow visible light to be transmitted therethrough;
a light source emitting illumination light containing visible light to illuminate the light emitting zone; and
a light guide for changing a light path of the illumination light emitted from the light source so that the illumination light exits from the light emitting zone to an outside of the housing.

2. The pointing device according to claim 1, wherein the light guide comprises a guide body accommodated within the housing, and an illumination guide provided at the guide body to change the light path of the illumination light.

3. The pointing device according to claim 2, wherein the illumination guide is provided on an outer wall of the guide body to disperse the illumination light such that the illumination light is widely spread in the light emitting zone to exit to the outside of the housing.

4. The pointing device according to claim 3, wherein the illumination guide comprises a plurality of reflective portions provided along a circumference of the guide body to reflect the illumination light, each of the reflective portions dispersing the illumination light emitted from the light source to both sides thereof.

5. The pointing device according to claim 4, wherein each of the reflective portions comprises a reflective protrusion formed on an outer surface of the guide body, and a pair of inclined reflective surfaces defining both side surfaces of the reflective protrusion and having a gap therebetween gradually narrowed towards the light source.

6. The pointing device according to claim 3, wherein the illumination guide comprises a plurality of refractive portions provided along a circumference of the guide body to refract the illumination light, each of the refractive portions dispersing the illumination light emitted from the light source to both sides thereof.

7. The pointing device according to claim 3, wherein the guide body comprises a plurality of outer surfaces in a circumferential direction thereof; and the illumination guide comprises any one of a reflective portion and a refractive portion provided to each of the outer surfaces of the guide body along the circumference of the guide body, each reflective portion dispersing the illumination light toward both sides thereof by reflection, the refractive portion dispersing the illumination light toward both sides thereof by refraction.

8. The pointing device according to claim 2, wherein the illumination guide comprises an eave disposed on an outer wall of the guide body to cover a front side of the light source.

9. The pointing device according to claim 8, wherein the eave has an inclined surface reflecting the illumination light to be spread along the illumination guide.

10. The pointing device according to claim 2, wherein the guide body is integrally formed with the illumination guide or is inserted into the illumination guide to be surrounded by the illumination guide.

11. The pointing device according to claim 2, wherein the guide body defines a path of detection light incident on the detector for detecting movement of the object.

12. The pointing device according to claim 1, wherein the housing body comprises a cover having an object detection zone and a visible light transmitting portion allowing the illumination light to be transmitted therethrough and having the light emitting zone on a surface thereof, the light emitting zone is formed on the cover, and the object detection zone defines a contact surface of the object for detecting the object.

13. The pointing device according to claim 12, wherein the light emitting zone is provided along a circumference of the cover for surrounding the circumference of the cover.

14. The pointing device according to claim 13, wherein the visible light transmitting portion and the cover are integrally formed with each other by double injection molding.

15. The pointing device according to claim 13, wherein the visible light transmitting portion comprises a surface coating layer on an outer surface thereof to prevent leakage of the illumination light.

16. The pointing device according to claim 15, whereon the surface coating layer comprises a white coating layer for reflecting the illumination light such that the illumination light does not exit to the outside of the visible light transmitting portion.

17. The pointing device according to claim 16, whereon the surface coating layer further comprises a black coating layer formed on the white coating layer.

18. The pointing device according to claim 12, wherein the object detection zone is illuminated by a detection light source provided within the housing.

19. The pointing device according to claim 18, wherein the detection light source comprises an infrared source for emitting detection light containing an infrared band; and the object detection zone is an infrared band pass filter allowing substantially only an infrared band to pass therethrough and is illuminated by the infrared source.

20. The pointing device according to claim 18, wherein the detection light source comprises a laser light source.

21. The pointing device according to claim 1, wherein the detector is capable of recognizing fingerprints.

22. The pointing device according to claim 1, wherein the light emitting zone forms decorative illumination of the housing.

23. The pointing device according to claim 1, wherein the light emitting zone has a metal coating layer on a surface thereof.

24. The pointing device according to claim 23, wherein the metal coating layer is formed by NCVM (Non-Conductive Vacuum Metalizing).

25. A portable electronic apparatus, comprising;
the pointing device according to claim 1; and
a main body to which the pointing device mounted.

26. A light guide of a pointing device including a housing having a light emitting zone to implement decorative illumination on a circumference of a cover, a detector for detecting movement of an object, and a light source for illuminating the light emitting zone, the light guide comprising:
a guide body accommodated within the housing; and
an illumination guide provided on the guide body to disperse illumination light emitted from the light source such that the illumination light is widely spread in the light emitting zone and exits to an outside of the housing.

27. The light guide according to claim 26, wherein the illumination guide comprises a plurality of reflective portions provided along a circumference of the guide body and reflecting the illumination light to disperse the illumination light.

28. The light guide according to claim 26, wherein the illumination guide comprises a plurality of refractive portions provided along a circumference of the guide body and refracting the illumination light to disperse the illumination light.

29. The light guide according to claim 26, wherein the illumination guide comprises an eave provided on an outer wall of the guide body to cover a front side of the light source.

30. The light guide according to claim 26, wherein the guide body has a plurality of outer surfaces in a circumferential direction thereof; and the illumination guide includes any one of a reflective portion and a refractive portion provided to each of the outer surfaces of the guide body along the circumference of the guide body, the reflective portion dispersing the illumination light toward both sides thereof by reflection, the refractive portion dispersing the illumination light toward both sides thereof by refraction.

31. The light guide according to claim 26, wherein the guide body defines a path of detection light incident on the detector for detecting movement of the object by the detector.

32. A method of manufacturing a housing of a pointing device comprising:
(a) manufacturing a housing body including a cover having an infrared band pass filter type object detection zone and a visible light transmitting portion allowing visible light to be transmitted therethrough to form a light emitting zone;
(b) forming a surface coating layer on a circumference of the housing body to prevent leakage of illumination light, with a mask formed on a surface of the housing body to cover the light emitting zone and the object detection zone; and
(c) forming a UV resin coating layer by coating the light emitting zone and the object detection zone with a UV resin after removing the mask.

33. The method according to claim 32, further comprising:
(d) performing NCVM treatment on an upper surface of the UV resin coating layer to form a metal coating layer;
(e) forming an outer UV resin coating layer on the metal coating layer; and
(f) removing portions of the UV resin coating layer, the metal coating layer and the outer UV resin coating layer formed on the surface of the object detection zone.

34. The method according to claim 32, wherein the step (b) comprises (b1) forming a white coating layer on the circumference of the housing and (b2) forming a black coating layer on the white coating layer.

35. The method according to claim 33, wherein the step (b) comprises (b1) forming a white coating layer on the circumference of the housing and (b2) forming a black coating layer on the white coating layer.
